(19) United States
(12) Patent Application Publication
(10) Pub. No.: US 2020/0126224 A1
(43) Pub. Date: Apr. 23, 2020

(54) IMAGE PROCESSING DEVICE, RECORDING MEDIUM, AND IMAGE PROCESSING METHOD

(71) Applicant: OLYMPUS CORPORATION, Tokyo (JP)

(72) Inventors: Toshiya KAMIYAMA, Tokyo (JP); Makoto KITAMURA, Tokyo (JP); Takashi KONO, Tokyo (JP); Hirokazu GODO, Tokyo (JP); Katsuyoshi TANIGUCHI, Tokyo (JP); Yamato KANDA, Tokyo (JP)

(73) Assignee: OLYMPUS CORPORATION, Tokyo (JP)

(21) Appl. No.: 16/720,595

(22) Filed: Dec. 19, 2019

Related U.S. Application Data
(63) Continuation of application No. PCT/JP2017/023102, filed on Jun. 22, 2017.

(51) Int. Cl. G06T 7/00; G06K 9/46

(52) U.S. Cl. CPC G06T 7/0012; G06K 9/4604; G06T 2207/10068; G06T 2207/30096; G06K 9/4652

(57) ABSTRACT

An image processing device includes a processor. The processor detects a lesion candidate based on a medical image obtained by picking up an image of a subject, detects a feature including a swelling direction of the lesion candidate, determines a display state of a mark displayed according to the feature of the lesion candidate, generates mark display information including information on the display state, and determines a position of the mark in a predetermined peripheral region of the lesion candidate according to the detected swelling direction. The image processing device generates a display image in which the mark is added to the position of the mark of the medical image based on the mark display information.

### CROSS REFERENCE TO RELATED APPLICATION

This application is a continuation application of PCT/JP2017/023102 filed on Jun. 22, 2017, the entire contents of which are incorporated herein by this reference.

### BACKGROUND OF THE INVENTION

### 1. Field of the Invention

The present invention relates to an image processing device, a recording medium, and an image processing method.

### 2. Description of the Related Art

Conventionally, there has been proposed an image processing device which indicates a portion where a lesion candidate included in a medical image is present. For example, Japanese Patent Application Laid-Open Publication No. 2004-180987 discloses a medical image display device which, for the purpose of reducing a fatigue of a user, sequentially displays a medical image by moving the medical image on a display screen vertically and horizontally such that a portion where an abnormal shadow or an abnormal candidate shadow is present and a display position of a mark are positioned at approximately a place on the display screen.

### SUMMARY OF THE INVENTION

According to an aspect of the present invention, there is provided an image processing device including a processor, wherein the processor is configured to: detect a lesion candidate based on a medical image obtained by picking up an image of a subject; detect a feature including a swelling direction of the lesion candidate; determine a display state of a mark displayed according to the feature of the lesion candidate, and generate mark display information including information on the display state; and determine a position of the mark in a predetermined peripheral region of the lesion candidate according to the detected swelling direction, and the image processing device is configured to generate a display image in which the mark is added at the position of the mark of the medical image based on the mark display information.

According to another aspect of the present invention, there is provided a computer readable non-transitory recording medium in which an image processing program is recorded, the recording medium including: a code in accordance with which a lesion candidate is detected based on a medical image obtained by picking up an image of a subject; a code in accordance with which a feature including a swelling direction of the lesion candidate is detected, a code in accordance with which a display state of a mark which is displayed is determined according to the feature of the lesion candidate, and mark display information including the information on the display state is generated; a code in accordance with which a position of the mark in a predetermined peripheral region of the lesion candidate is determined according to the detected swelling direction; and a code in accordance with which a display image is generated by adding the mark to a position of the mark of the medical image based on the mark display information.

According to another aspect of the present invention, there is provided an image processing method including the steps of: detecting a lesion candidate based on a medical image obtained by picking up an image of a subject; detecting a feature including a swelling direction of the lesion candidate; determining a display state of a mark which is displayed according to a feature of the lesion candidate, and generating mark display information including information on the display state; determining a position of the mark in a predetermined peripheral region of the lesion candidate according to the detected swelling direction; and generating a display image by adding the mark to a position of the mark of the medical image based on the mark display information.

### BRIEF DESCRIPTION OF THE DRAWINGS

FIG. 1 is a block diagram showing one example of the configuration of an endoscope apparatus according to an embodiment of the present invention;

FIG. 2 is a block diagram showing one example of the configuration of a mark control section of an image processing device of the endoscope apparatus according to the embodiment of the present invention;

FIG. 3 is an explanatory diagram for describing a binarization operation of the image processing device of the endoscope apparatus according to the embodiment of the present invention;

FIG. 4 is an explanatory diagram for describing a display example of marks in the endoscope apparatus according to the embodiment of the present invention;

FIG. 5 is an explanatory diagram for describing a display example of marks in the endoscope apparatus according to the embodiment of the present invention;

FIG. 6 is an explanatory diagram for describing a display example of marks in the endoscope apparatus according to the embodiment of the present invention;

FIG. 7 is an explanatory diagram for describing a display example of marks in the endoscope apparatus according to the embodiment of the present invention;

FIG. 8 is an explanatory diagram for describing a display example of marks in the endoscope apparatus according to the embodiment of the present invention;

FIG. 9 is an explanatory diagram for describing a display example of marks in the endoscope apparatus according to the embodiment of the present invention; and

FIG. 10 is a flowchart showing one example of a flow of a mark control processing of the image processing device of the endoscope apparatus according to the embodiment of the present invention.

### DETAILED DESCRIPTION OF THE PREFERRED EMBODIMENT

Hereinafter, an embodiment of the present invention is described with reference to drawings.

### (Configuration)

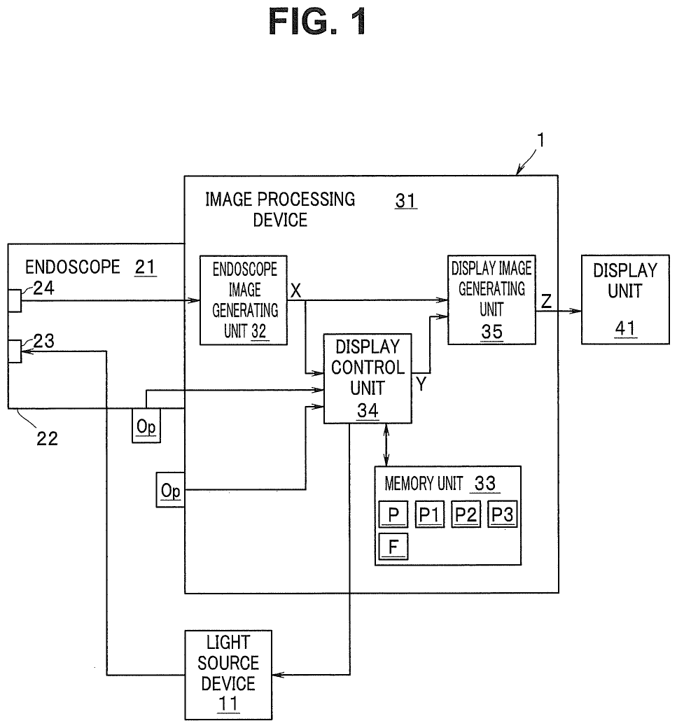

FIG. 1 is a block diagram showing one example of the configuration of an endoscope apparatus 1 according to the embodiment of the present invention.

The endoscope apparatus 1 includes a light source device 11, an endoscope 21, an image processing device 31, and a display unit 41. The light source device 11 is connected to the endoscope 21 and the image processing device 31 respectively. The endoscope 21 is connected to the image processing device 31. The image processing device 31 is connected to the display unit 41.

The light source device 11 outputs an illumination light to an illumination unit 23 mounted on a distal end portion of an insertion unit 22 of the endoscope 21 under a control of the image processing device 31.

The endoscope 21 is configured to pick up an image of the inside of a subject. The endoscope 21 includes the insertion unit 22, the illumination unit 23, an image pickup unit 24, and an operation unit Op.

The insertion unit 22 is formed in an elongated shape so that the insertion unit 22 can be inserted into the subject. Various tubes and signal lines not shown in the drawing are inserted into the insertion unit 22. The insertion unit 22 has a bending portion not shown in the drawing, and the bending portion is bendable in response to an input command transmitted from the operation unit Op.

The illumination unit 23 is mounted on the distal end portion of the insertion unit 22, and radiates an illumination light inputted from the light source device 11 to the subject.

The image pickup unit 24 includes an image pickup device such as a CCD. The image pickup unit 24 is mounted on the distal end portion of the insertion unit 22, picks up a return light from the subject, and outputs a pickup image signal to the image processing device 31.

The operation unit Op includes a command input device such as a button or a joy stick. The operation unit Op may include a command input device such as a touch panel, a keyboard, or a foot switch. The operation unit Op is disposed in the endoscope 21 and the image processing device 31 respectively, and can input various commands to the endoscope 21 and the image processing device 31. For example, the operation unit Op can input a command such as a bending command transmitted to the bending portion or a drive command transmitted to the light source device 11.

The image processing device 31 performs a control of respective units in the endoscope apparatus 1. Based on a pickup image signal inputted from the endoscope 21, the image processing device 31 generates an endoscope image X which is a medical image, generates mark display information Y based on the endoscope image X, generates a display image Z based on the endoscope image X and the mark display information Y, and outputs the display image Z to the display unit 41. The image processing device 31 includes, besides the operation unit Op, an endoscope image generating unit 32, a memory unit 33, a display control unit 34, and a display image generating unit 35.

The endoscope image generating unit 32 is a circuit which performs on image processing based on a pickup image signal inputted from the image pickup unit 24, and generates the endoscope image X. The endoscope image generating unit 32 generates the endoscope the image X by performing image processing such as gain adjustment, white balance adjustment, gamma correction, profile intensifying correction, or enlargement or contraction adjustment based on the pickup image signal, and outputs the endoscope image X to the display control unit 34 and the display image generating unit 35.

The memory unit 33 includes a memory element such as a rewritable ROM. In the memory unit 33, besides a program for controlling the respective units of the endoscope apparatus 1, data F and a program of the mark control section P are also stored.

The display control unit 34 is a circuit which performs a control of the respective units in the endoscope apparatus 1. The display control unit 34 is a processor including a central processing unit (CPU), for example. In this embodiment, the processor may be realized in a form that functions of the respective units are performed by individual hardware, or in a form that some of the respective units are performed by integral hardware, for example. The processor includes hardware, for example, and the hardware may include at least one of a circuit which processes digital signals and a circuit which processes analog signals. As the processor, various processors can be used such as a DSP (digital signal processor) besides the CPU (central processing unit). The processor may be a hardware circuit formed of an ASIC (application specific integrated circuit) or an FPGA (field programmable gate array).

The display control unit 34 is connected to the memory unit 33, and can read information such as various programs and the like from the memory unit 33. The function of the display control unit 34 is realized by executing a program stored in the memory unit 33. The display control unit 34 is connected to the display unit 41, and generates mark display information Y for controlling the display of a mark based on the endoscope image X, and outputs the mark display information Y to the display image generating unit 35. The endoscope image X may be either a moving image or a still image.

The display control unit 34 outputs a control signal in response to a command input which is inputted from the operation unit Op, and controls the light source device 11. The display control unit 34 may adjust a light emission quantity of the illumination unit 23 in response to brightness of the endoscope image X.

The display image generating unit 35 is a circuit for generating a display image Z by adding a mark to a medical image based on the mark display information Y. The display image generating unit 35 generates the display image Z based on the endoscope image X inputted from the endoscope image generating unit 32 and the mark display information Y inputted from the display control unit 34, and outputs the display image Z on the display unit 41. Note that although the display image generating unit 35 is formed of a circuit, the display image generating unit 35 may be formed of a processor having a CPU.

The display unit 41 is formed of a monitor capable of displaying a color image, for example. The display unit 41 displays the display image Z inputted from the display image generating unit 35.

### (Configuration of Data F)

Data F includes a lesion detection threshold value, a kind threshold value, a clearness threshold value, a size threshold value, a bubble and residue threshold value, and a brightness threshold value described later.

Data F also includes a mean vector μ, a variance-covariance matrix Z, and a predetermined threshold value which are preliminarily set in accordance with a detection object.

The mean vector μ and the variance-covariance matrix Z are calculated by an equation (1) based on a feature vector Fn=(fn1, fn2, fnj, . . . , fnk)^{T} obtained by sampling feature values of teacher data which is a detection object. In the equation (1), fnj indicates a feature value sampled at the j-th of the n-th teacher data, k indicates the number of feature values, and ND is the number of sampling data.

$$\begin{matrix}[ Equation 1 ] & \\ μ = \frac{1}{ND} {\sum }_{n = 1}^{ND} Fn , \\ Z = \frac{1}{ND} {\sum }_{n = 1}^{ND} ( Fn - μ ) {( Fn - μ )}^{t} & ( 1 )\end{matrix}$$

A predetermined threshold value is preliminarily set in accordance with a determination index Di such that whether or not a detection object is included in the endoscope image X can be detected.

The determination index Di is calculated using an equation (2) by sampling a feature value in accordance with the detection object and by calculating the feature vector x=(x1, x2, xj, . . . xk)^{T}. In the equation (2), xj is a feature value sampled at the j-th, and xk is the number of feature values.

$$\begin{matrix}[ Equation 2 ] & \\ D i ( x ) = \frac{1}{{( 2 π )}^{k / 2} \times {\vert Z \vert}^{1 / 2}} exp \{ {( x - μ )}^{t} \times - \frac{1}{2} {Z}^{- 1} \times ( x - μ ) \} & ( 2 )\end{matrix}$$

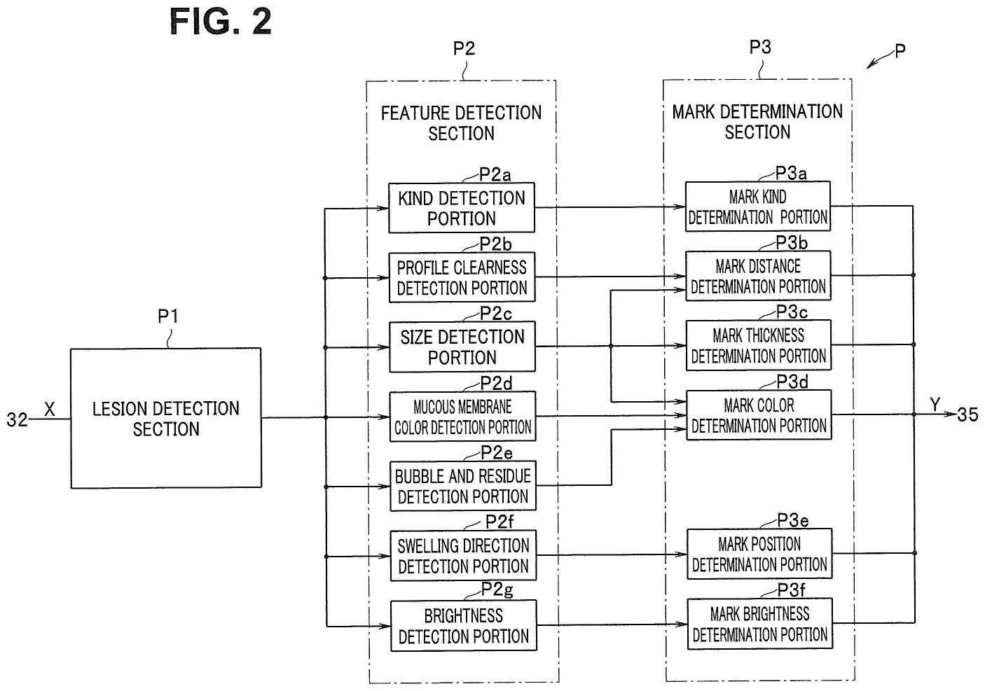

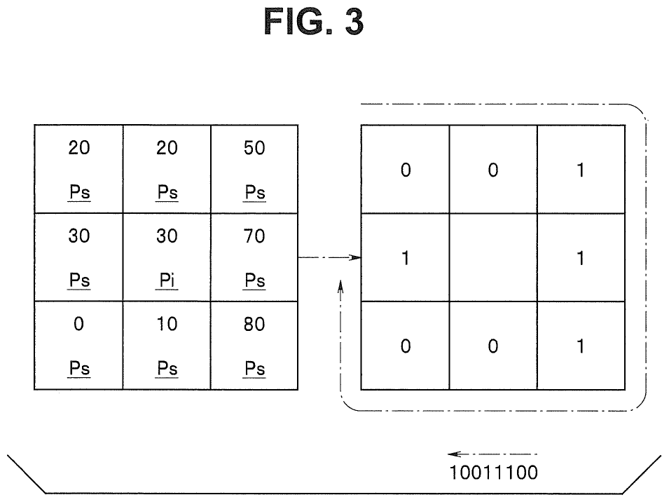

FIG. 2 is a block diagram showing one example of the configuration of the mark control section P of the image processing device 31 of the endoscope apparatus 1 according to the embodiment of the present invention. FIG. 3 is an explanatory diagram for describing the binarization operation of the image processing device 31 of the endoscope apparatus 1 according to the embodiment of the present invention.

As shown in FIG. 2, the mark control section P performs a processing for generating the mark display information Y for controlling a display state of a mark in the display image Z based on the endoscope image X inputted from the endoscope image generating unit 32. The mark control section P includes a lesion detection section P1, a feature detection section P2, and a mark determination section P3.

The feature detection section P2 includes a kind detection portion P2a, a profile clearness detection portion P2b, a size detection portion P2c, a mucous membrane color detection portion P2d, a bubble and residue detection portion P2e, a swelling direction detection portion P2f, and a brightness detection portion P2g.

The mark determination section P3 includes a mark kind determination portion P3a, a mark distance determination portion P3b, a mark thickness determination portion P3c, a mark color determination portion P3d, a mark position determination portion P3e, and a mark brightness determination portion P3f.

### (Configuration of Lesion Detection Section P1)

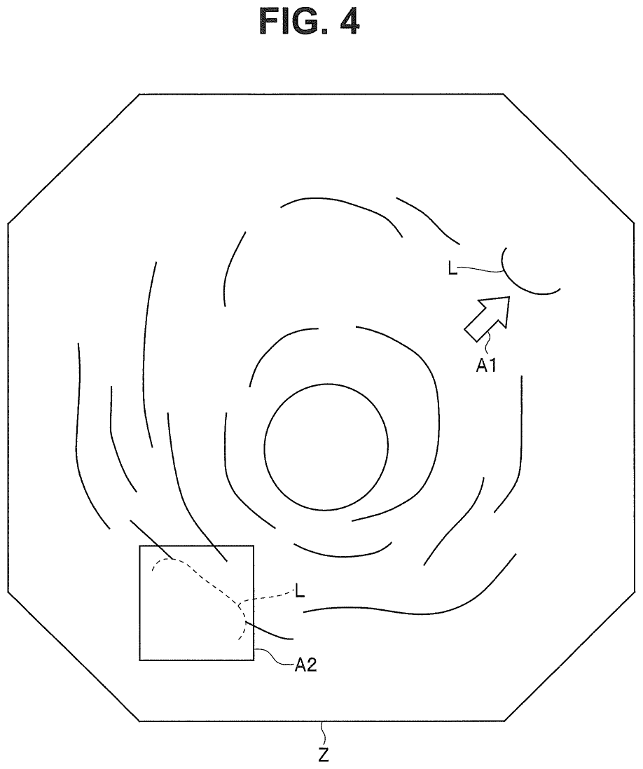

The lesion detection section P1 detects lesion candidates L shown in FIG. 4 to FIG. 9 based on the endoscope image X, and performs a processing to output a detection result including coordinate information to the feature detection section P2. In other words, the lesion detection section P1 detects the lesion candidate L based on a medical image obtained by picking up an image of a subject.

The lesion detection section P1 calculates a color feature value. The color feature value is calculated based on a color ratio calculated by a green pixel value/a red pixel value, for example. Note that a color feature value may be calculated based on a color ratio calculated by a blue pixel value/a green pixel value, may be calculated based on color difference calculated by YCbCr conversion, hue, or chroma calculated by HSI conversion, or may be calculated based on any one of a red pixel value, a green pixel value, or a blue pixel value.

The lesion detection section P1 divides the endoscope image X into a plurality of small regions, and a color feature value is calculated with respect to respective small regions.

The lesion detection section P1 also calculates a texture feature value using an LBP (local binary pattern) technique, for example.

As exemplified in FIG. 3, the lesion detection section P1 applies a binarization processing to a pixel region formed of a 3×3 pixel matrix formed of one target pixel Pi and eight peripheral pixels Ps arranged so as to surround the target pixel Pi.

In the binarization processing, the lesion detection section P1 obtains pixel values of the peripheral pixels Ps one by one in a clockwise direction, binarizes the respective pixel values, and sets the binarized values from a low-order bit to a high-order bit thus generating binary data.

For example, “1” is set when the pixel value of the peripheral pixel Ps is equal to or more than the pixel value of the target pixel Pi, and “0” is set when the pixel value of the peripheral pixel Ps is less than the pixel value of the target pixel Pi. In the example shown in FIG. 3, the binary data of “10011100” is generated by the binarization processing.

The lesion detection section P1 generates binary data with respect to the pixel within the respective small regions, and generates the texture feature value expressed by a histogram for respective small regions.

The lesion detection section P1 reads a mean vector μ, a variance-covariance matrix Z, and a lesion detection threshold value set for lesion detection.

The lesion detection section P1, for respective small regions, calculates the feature vector x based on a color feature value and a texture feature value, performs an operation based on the equation (2), and calculates a determination index Di for lesion detection.

The lesion detection section P1 outputs the detection result to the feature detection section P2 according to the determination index Di for lesion detection and the lesion detection threshold value. For example, the lesion detection section P1 outputs a detection result which indicates that the lesion candidate L is detected and includes coordinate information of the lesion candidate L when the determination index Di for lesion detection is equal to or more than the lesion detection threshold value to the feature detection section P2. The coordinate information of the lesion candidate L may be determined by any arithmetic operation. For example, the coordinate information of the lesion candidate L may be determined based on positional information of the small regions.

### (Configuration of Feature Detection Section P2)

Returning to FIG. 2, based on the detection result inputted from the lesion detection section P1, the feature detection section P2 detects a feature of the lesion candidate L indicated in the coordinate information, and performs a processing for outputting the detection result including the coordinate information to the mark determination section P3.

Based on the detection result inputted from the lesion detection section P1, a kind detection portion P2a detects whether a kind of the lesion candidate L is a raised lesion or a flat lesion.

The kind detection portion P2a calculates a texture feature value. As the texture feature value, a texture feature value calculated by the lesion detection section P1 may be used.

The kind detection portion P2a also calculates a shape feature value. The shape feature value is calculated according to a circularity, a Feret diameter, and an area of the lesion candidate L.

The kind detection portion P2a reads a mean vector μ, variance-covariance matrix Z, and a kind threshold value set for kind detection from the memory unit 33.

The kind detection portion P2a calculates a feature vector x based on the lesion candidate L detected by the lesion detection section P1, performs an operation using the equation (2) so as to calculate a determination index Di for kind detection.

The kind detection portion P2a outputs a detection result to the mark kind determination portion P3a according to the determination index Di for kind detection and the kind threshold value. For example, the kind detection portion P2a outputs a detection result indicating that the lesion candidate L is a raised lesion when the determination index Di for kind detection is equal to or more than the kind threshold value. On the other hand, the kind detection portion P2a outputs a detection result indicating that the lesion candidate L is a flat lesion when the determination index Di for kind detection is less than the kind threshold value.

Note that, with respect to a lesion candidate L where a shape of the lesion candidate L cannot be specified due to spreading of the lesion candidate L largely on a surface of a mucous membrane, the kind threshold value may be set such that a detection result indicating that the lesion candidate L is a flat lesion is outputted.

The profile clearness detection portion P2b detects whether clearness of a profile of the lesion candidate L is equal to or more than a clearness threshold value or less than the clearness threshold value based on the detection result inputted from the lesion detection section P1.

The profile clearness detection portion P2b calculates the clearness of the profile of the lesion candidate L. The clearness of the profile of the lesion candidate L is calculated based on the brightness difference between the profile of the lesion candidate L and an outer portion of the profile. For example, the brightness difference is calculated by extracting the profile by performing a predetermined profile extracting operation and by subtracting a pixel value of the outer portion of the profile from a pixel value of the profile.

In the predetermined profile extracting operation, for example, the profile of the lesion candidate L is extracted by a morphological operation. As the predetermined profile extracting operation, other operations for extracting the profile may also be used.

The profile clearness detection portion P2b reads a clearness threshold value set for profile detection from the memory unit 33.

The profile clearness detection portion P2b outputs a detection result indicating whether the clearness of the profile is equal to or more than the clearness threshold value or less than the clearness threshold value according to the clearness of the profile and the clearness threshold value to the mark distance determination portion P3b.

The size detection portion P2c detects whether the lesion candidate L has a size equal to or more than a size threshold value or less than the size threshold value based on the detection result inputted from the lesion detection section P1.

The size detection portion P2c extracts a profile by performing a predetermined profile extracting operation, calculates an area of the lesion candidate L by performing a predetermined area calculation operation based on the profile, and divides the area of the lesion candidate L by an area of the display image Z thus calculating a rate of a region that the lesion candidate L occupies in the display image Z.

The size detection portion P2c reads a size threshold value set for size detection from the memory unit 33.

The size detection portion P2c outputs a detection result indicating that the size of the lesion candidate L is equal to or more than the size threshold value or less than the size threshold value to the mark distance determination portion P3b, the mark thickness determination portion P3c, and the mark color determination portion P3d.

The mucous membrane color detection portion P2d detects a mucous membrane color of a predetermined peripheral region of the lesion candidate L based on the detection result inputted from the lesion detection section P1.

The predetermined peripheral region is a region on a periphery of the lesion candidate L which is preliminarily set experimentally or empirically.

The mucous membrane color detection portion P2d extracts a profile by performing a predetermined profile extracting operation, acquires a mucous membrane color of the predetermined peripheral region of the lesion candidate L, calculates a mean value of the mucous membrane color, and outputs the calculation result to the mark color determination portion P3d as a detection result.

The bubble and residue detection portion P2e detects bubbles or a residue in the predetermined peripheral region of the lesion candidate L based on the detection result inputted from the lesion detection section P1.

With respect to a color feature value, white strongly appears in the bubbles and ocher strongly appears in the residue. With respect to a texture feature value, a profile strongly appears in the bubbles, and mirror reflection largely appears in the bubbles. The profile does not clearly appear in the residue.

The bubble and residue detection portion P2e calculates the color feature value and the texture feature value.

The bubble and residue detection portion P2e reads a mean vector μ, a variance-covariance matrix Z, and a bubble and residue threshold value set for bubbles or residue detection from the memory unit 33. The bubble and residue detection portion P2e calculates the feature vector x based on the color feature value and the texture feature value of a predetermined peripheral region of the lesion candidate L, and performs an operation using the equation (2) thus calculating a determination index Di for bubble and residue detection.

The bubble and residue detection portion P2e outputs a detection result to the mark color determination portion P3d according to the determination index Di for bubble and residue detection and the bubble and residue threshold value. For example, when the determination index Di for bubble and residue detection is equal to or more than the bubble and residue threshold value, the bubble and residue detection portion P2e outputs a detection result including color of the bubbles or the residue. On the other hand, when the determination index Di for bubble and residue detection is less than the bubble and residue threshold value, the bubble and residue detection portion P2e outputs a detection result indicating that neither the bubbles nor the residue is present.

The swelling direction detection portion P2f detects a swelling direction of the lesion candidate L based on the detection result inputted from the lesion detection section P1.

When the lesion candidate L swells from a mucous membrane, in the endoscope image X, an arcuate line appears on a swelling side, and both ends of the arcuate line appear on a proximal portion side.

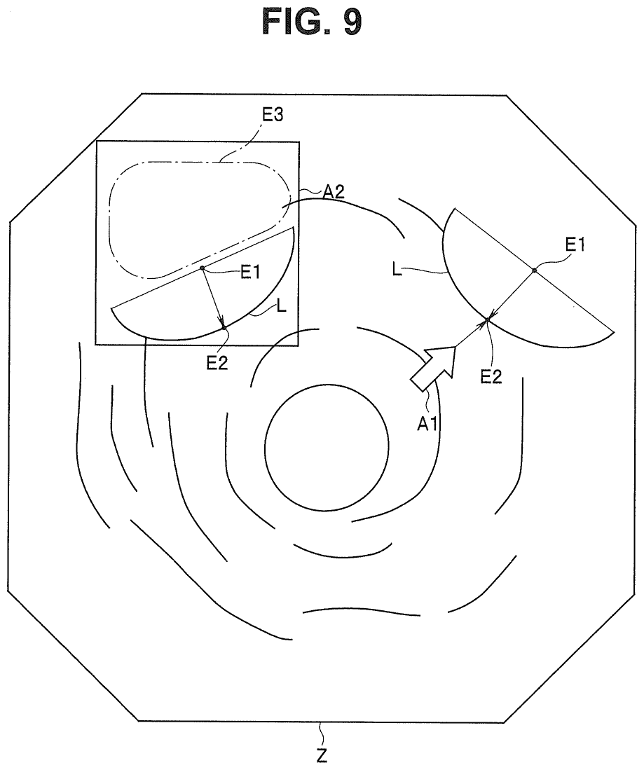

The swelling direction detection portion P2f extracts a profile by performing a predetermined profile extracting operation, calculates a first center point E1 on an imaginary line which connects the both ends of the arcuate line, calculates a second center point E2 on the arcuate line, and calculates a swelling direction of the lesion candidate L extending from the first center point E1 to the second center point E2. As a detection result, the swelling direction detection portion P2f outputs the calculated swelling direction of the lesion candidate L to the mark position determination portion P3e (see FIG. 9).

The brightness detection portion P2g detects whether brightness of the predetermined peripheral region of the lesion candidate L is equal to or more than the brightness threshold value or less than the brightness threshold value, based on the detection result inputted from the lesion detection section P1.

The brightness detection portion P2g reads a brightness threshold value set for brightness detection from the memory unit 33.

The brightness detection portion P2g extracts a profile by performing a predetermined profile extracting operation, and calculates a mean value of brightness of the predetermined peripheral region of the lesion candidate L.

The brightness detection portion P2g outputs a detection result indicating that the brightness in the predetermined peripheral region of the lesion candidate L is equal to or more than the brightness threshold value or less than the brightness threshold value according to the brightness and the brightness threshold value to the mark brightness determination portion P3f.

### (Configuration of Mark Determination Section P3)

FIG. 4 to FIG. 9 are explanatory diagrams for describing display examples of marks in the endoscope apparatus 1 according to the embodiment of the present invention. FIG. 4 to FIG. 9 are display examples of the display image Z based on the endoscope image X where lumen in a subject is picked up as an image.

The mark determination section P3 determines a display state of a mark which indicates the lesion candidate L included in the coordinate information based on the detection result inputted from the feature detection section P2, generates the mark display information Y including the coordinate information and information on the display state, and performs a processing for outputting the mark display information Y to the display image generating unit 35.

In other words, the mark determination section P3 determines the display state of the mark which is displayed according to a feature of the lesion candidate L, and generates the mark display information Y including the information on the display state.

The mark kind determination portion P3a determines a kind of the mark based on the detection result inputted from the kind detection portion P2a.

In FIG. 4, a raised lesion is indicated by a solid line, and a flat lesion is indicated by a broken line.

As shown in FIG. 4, the mark kind determination portion P3a makes a determination to set the kind of the mark to a position mark A1 indicating the position of the lesion candidate L when the kind of the lesion candidate L is a raised lesion. The mark kind determination portion P3a makes a determination to set the kind of the mark to a region mark A2 indicating a region of the lesion candidate L when the kind of the lesion candidate L is a flat lesion.

In other words, the mark kind determination portion P3a determines the kind of the mark according to the kind of the lesion candidate L among plural kinds of marks.

The mark distance determination portion P3b determines a distance between the lesion candidate L and the mark based on the detection result inputted from the profile clearness detection portion P2b or the size detection portion P1c.

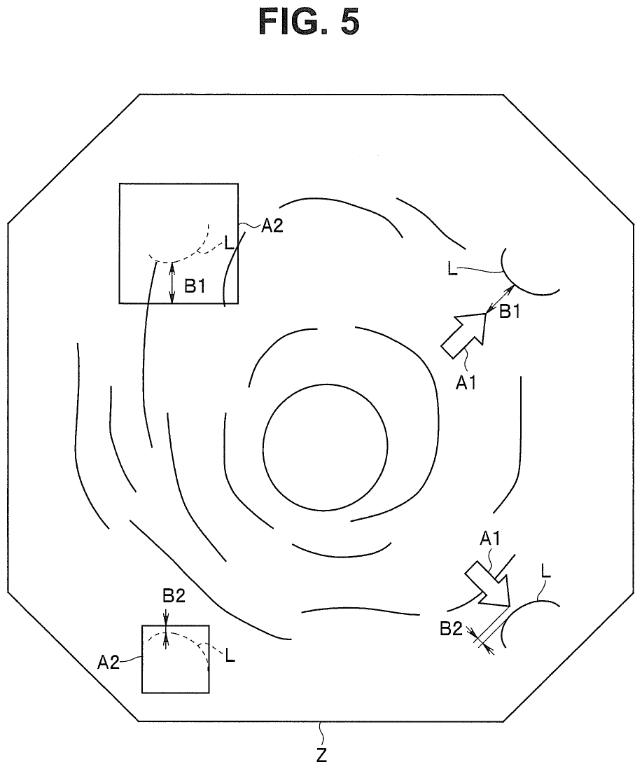

As shown in FIG. 5, when the clearness of a profile of the lesion candidate L is equal to or more than the clearness threshold value, the mark distance determination portion P3b makes a determination to set the distance between the lesion candidate L and the mark to a first predetermined distance B1. When the clearness of a profile of the lesion candidate L is less than the clearness threshold value, the mark distance determination portion P3b makes a determination to set the distance between the lesion candidate L and the mark to a second predetermined distance B2 which is shorter than the first predetermined distance B1.

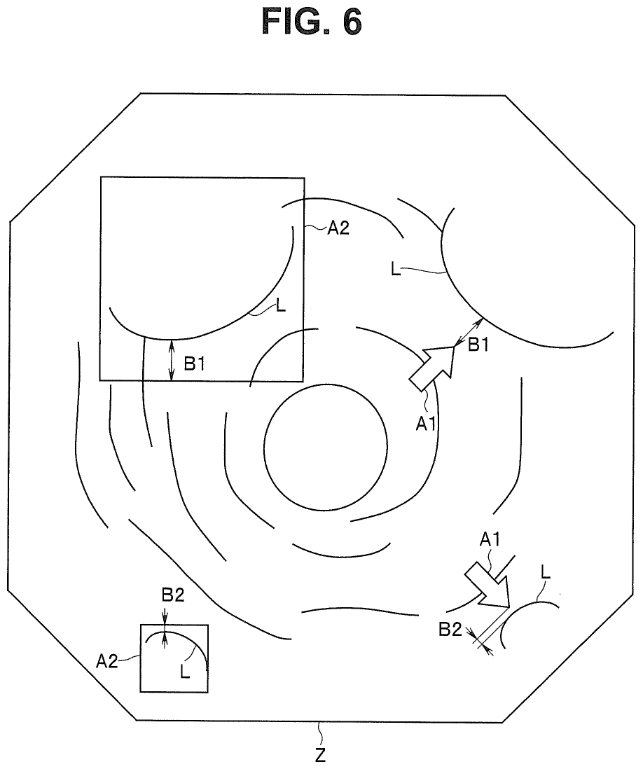

As shown in FIG. 6, when a size of the lesion candidate L is equal to or more than the size threshold value, the mark distance determination portion P3b makes a determination to set the distance between the lesion candidate L and the mark to the first predetermined distance B1. When the size of the lesion candidate L is less than the size threshold value, the mark distance determination portion P3b makes a determination to set the distance between the lesion candidate L and the mark to the second predetermined distance B2 which is shorter than the first predetermined distance B1.

When a plurality of distances which differ from each other are determined based on the detection results inputted from the profile clearness detection portion P2b and the size detection portion P2c, the mark distance determination portion P3b determines either one of the distances in accordance with the predetermined order of precedence.

The mark thickness determination portion P3c determines the thickness of a line of the mark based on the detection result inputted from the size detection portion P2c.

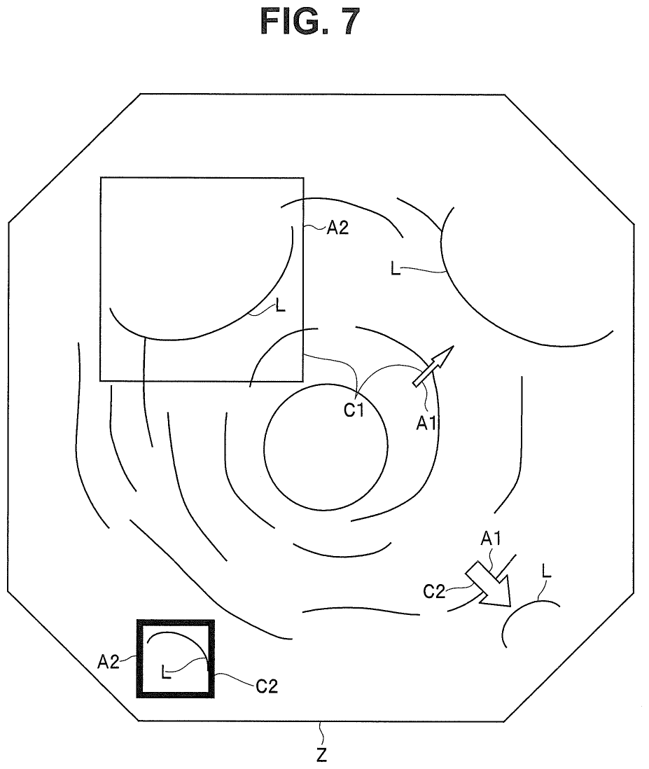

As shown in FIG. 7, when the size of the lesion candidate L is equal to or more than a size threshold value, the mark thickness determination portion P3c makes a determination to set the thickness of the line of the mark to a first predetermined thickness C1. When the size of the lesion candidate L is less than the size threshold value, the mark thickness determination portion P3c makes a determination to set the thickness of the line of the mark to a second predetermined thickness C2 which is larger than the first predetermined thickness C1.

The mark color determination portion P3d determines a color of the mark based on the detection results inputted from the size detection portion P2c, the mucous membrane color detection portion P2d, and the bubble and residue detection portion P2e.

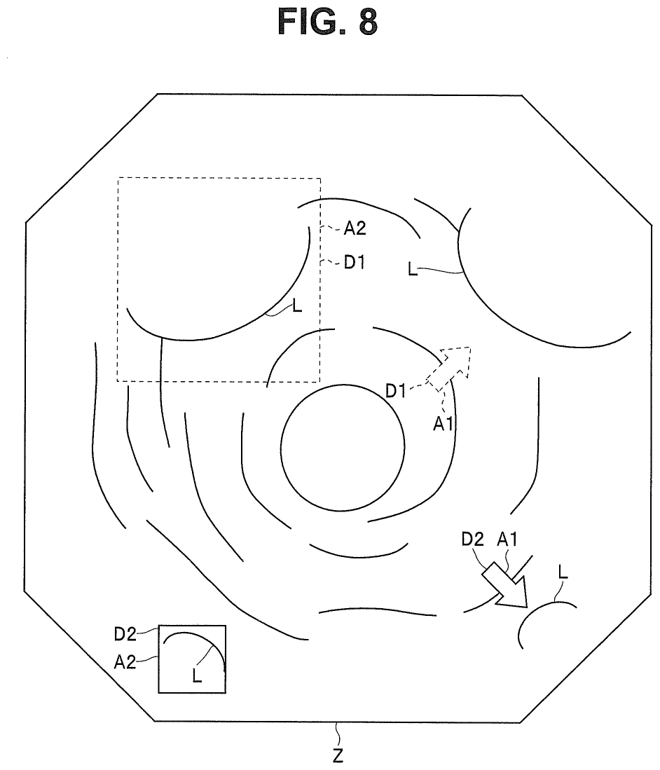

In FIG. 8, a first predetermined color D1 is expressed by a broken line schematically, and a second predetermined color D2 is schematically expressed by a solid line.

As shown in FIG. 8, when the size of the lesion candidate L is equal to or more than the size threshold value, the mark color determination portion P3d makes a determination to set the color of the mark to the first predetermined color D1. When the size of the lesion candidate L is less than the size threshold value, the mark color determination portion P3d makes a determination to set the color of the mark to the second predetermined color D2.

The second predetermined color D2 is set to a color more apparent than the first predetermined color D1 experimentally or empirically. For example, the second predetermined color D2 may be a color which is evaluated as more apparent than the first predetermined color D1 by many people by a subjective evaluation test, or may be a color having a higher brightness or a higher chroma than the first predetermined color D1.

The mark color determination portion P3d determines a color of the mark by performing a predetermined color arithmetic operation in accordance with mucous membrane color based on the detection result inputted from the mucous membrane color detection portion P2d.

The mark color determination portion P3d determines a color of the mark by performing a predetermined color arithmetic operation in accordance with a color of the bubbles or the residue based on a detection result inputted from the bubble and residue detection portion P2e.

The predetermined color arithmetic operation is set experimentally or empirically. The predetermined color arithmetic operation may be, for example, an operation which calculates the color farthest in distance in a predetermined color space, or may be an operation which calculates a complementary color. Further, the predetermined color arithmetic operation is performed so as to exclude an inappropriate color such as red which is confusing with a color of blood, for example.

When a plurality of colors which differ from each other are determined by all of or some of the size detection portion P2c, the mark color determination portion P3d, and the bubble and residue detection portion P2e, the mark color determination portion P3d determines one color of the mark in accordance with the predetermined order of precedence.

The mark position determination portion P3e determines the position of the mark in the predetermined peripheral region of the lesion candidate L according to the swelling direction of the lesion candidate L based on the detection result inputted from the swelling direction detection portion P2f.

As shown in FIG. 9, when the swelling direction is inputted from the swelling direction detection portion P2f to the mark position determination portion P3e, the mark position determination portion P3e determines the display position of the mark such that the mark is not arranged in a predetermined region E3 outside a base portion of the lesion candidate L.

The mark position determination portion P3e obtains a kind of the mark from the mark kind determination portion P3a. When the kind of the mark is the position mark A1, the swelling direction detection portion P2f makes a determination to set the display position to a position at which the position mark A1 indicates the second center point E2 from the outside of a swelling side of the lesion candidate L. On the other hand, when the kind of the mark is the region mark A2, the swelling direction detection portion P2f makes a determination to set the display position to a position at which the lesion candidate L and the predetermined region E3 on the outside of a base portion side of the lesion candidate L are surrounded by the region mark A2. The predetermined region on the outside of the base portion is set experimentally and empirically such that a user can observe a boundary between the lesion candidate L and a normal mucous membrane.

The mark brightness determination portion P3f determines the brightness of the mark according to the brightness of the predetermined peripheral region of the lesion candidate L based on the detection result inputted from the brightness detection portion P2g.

When the brightness of the predetermined peripheral region of the lesion candidate L is higher than the brightness threshold value, the mark brightness determination portion P3f makes a determination to set the brightness of the mark to a first predetermined brightness which is lower than the brightness threshold value. When the brightness of the predetermined peripheral region of the lesion candidate L is lower than the brightness threshold value, the mark brightness determination portion P3f makes a determination to set the brightness of the mark to a second predetermined brightness which is higher than the brightness threshold value.

In other words, an image processing program which forms the mark control section P causes a computer to execute: a code for performing detection of the lesion candidate L based on a medical image obtained by picking up an image of a subject; a code for performing detection of a feature of the lesion candidate L, a code for determining a display state of a mark which is displayed according to the feature of the lesion candidate L and for generating mark display information Y including information on the display state, and a code for generating a display image Z by adding a mark to a medical image based on the mark display information Y.

In other words, in the image processing method, the lesion candidate L is detected based on a medical image obtained by picking up an image of a subject, a feature of the lesion candidate L is detected, a display state of a mark which is displayed is determined according to the feature of the lesion candidate L, mark display information Y including information on the display state is generated, and a display image Z is generated by adding the mark to the medical image.

### (Operation)

Subsequently, an operation of the image processing device 31 of the endoscope apparatus 1 is described.

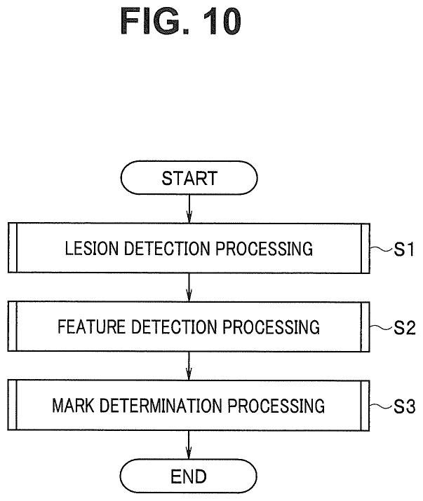

FIG. 10 is a flowchart showing one example of the flow of a mark control processing of the image processing device 31 of the endoscope apparatus 1 according to the embodiment of the present invention.

When a user performs command inputting for starting the endoscope apparatus 1 by the operation unit Op, the display control unit 34 reads a program of the mark control section P from the memory unit 33.

When the user inserts the insertion unit 22 into the subject and the image pickup unit 24 picks up an image of the inside of a subject, the image pickup unit 24 outputs a pickup image signal to the endoscope image generating unit 32. The endoscope image generating unit 32 generates the endoscope image X by performing the image processing based on the pickup image signal, and outputs the endoscope image X to the display control unit 34 and the display image generating unit 35.

The display control unit 34 executes the program of the mark control section P, and starts the mark control processing.

Lesion detection processing is performed (S1). The display control unit 34 performs the lesion detection processing by executing the program of the lesion detection section P1. The lesion detection section P1 divides an endoscope image X into small regions, calculates the color feature value and the texture feature value with respect to the respective small regions, and performs the detection of a lesion candidate L. When the lesion candidate L is detected, the lesion detection section P1 outputs a detection result including coordinate information of the lesion candidate L to the feature detection section P2.

Feature detection processing is performed (S2). The display control unit 34 performs a feature detection processing of the lesion candidate L indicated in the coordinate information by executing a program of the feature detection section P2.

The feature detection section P2 includes the kind detection portion P2a, the profile clearness detection portion P2b, the size detection portion P2c, the mucous membrane color detection portion P2d, the bubble and residue detection portion P2e, the swelling direction detection portion P2f, and the brightness detection portion P2g. Processing in the respective processing portions of the feature detection section P2 are executed in series or in parallel.

The kind detection portion P2a detects whether the lesion candidate L is a raised lesion or a flat lesion, and outputs a detection result to the mark kind determination portion P3a.

The profile clearness detection portion P2b detects whether a profile of the lesion candidate L is clear or obscure, and outputs a detection result to the mark distance determination portion P3b.

The size detection portion P2c detects a magnitude of a size of the lesion candidate L, and outputs a detection result to the mark distance determination portion P3b, the mark thickness determination portion P3c, and the mark color determination portion P3d.

The mucous membrane color detection portion P2d detects a color of mucous membrane of a predetermined peripheral region of the lesion candidate L, and outputs a detection result to the mark color determination portion P3d.

The bubble and residue detection portion P2e detects colors of bubbles and a residue of the predetermined peripheral region of the lesion candidate L, and outputs a detection result to the mark color determination portion P3d.

The swelling direction detection portion P2f detects a swelling direction of the lesion candidate L, and outputs a detection result to the mark position determination portion P3e.

The brightness detection portion P2g detects a level of a brightness of the lesion candidate L, and outputs a detection result to the mark brightness determination portion P3f.

Mark determination processing is performed (S3). The display control unit 34 performs the mark determination processing of the lesion candidate L indicated in the coordinate information by executing a program of the mark determination section P3, and outputs the mark display information Y to the display image generating unit 35.

The mark determination section P3 includes the mark kind determination portion P3a, the mark distance determination portion P3b, the mark thickness determination portion P3c, the mark color determination portion P3d, the mark position determination portion P3e, and the mark brightness determination portion P3f. Processing in the respective processing portions of the mark determination section P3 are performed in series or in parallel.

As shown in FIG. 4, when the lesion candidate L is a raised lesion, the mark kind determination portion P3a makes a determination to set the kind of the mark to the position mark A1 such that the mark can indicate the lesion candidate L. In the example shown in FIG. 4, the position mark A1 is an arrow image.

When the lesion candidate L is a flat lesion, the mark kind determination portion P3a makes a determination to set the kind of the mark to the region mark A2 such that the mark can indicate the lesion candidate L as a region. In the example shown in FIG. 4, the region mark A2 is a rectangular frame image.

As shown in FIG. 5, when a clearness of the profile of the lesion candidate L is equal to or more than the clearness threshold value, the mark distance determination portion P3b makes a determination to set the distance between the lesion candidate L and the mark to the first predetermined distance B1 so as to prevent the occurrence of a case where the mark is so close to the lesion candidate L that a user gets stressed.

When the clearness of the profile of the lesion candidate L is less than the clearness threshold value, the mark distance determination portion P3b makes a determination to set the distance between the lesion candidate L and the mark to the second predetermined distance B2 so as to prevent the occurrence of a case where the mark is so far from the lesion candidate L that the mark is hardly recognized.

As shown in FIG. 6, when the size of the lesion candidate L is equal to or more than the size threshold value, the mark distance determination portion P3b makes a determination to set the distance between the lesion candidate L and the mark to the first predetermined distance B1 so as to prevent the occurrence of a case where the mark is so close to the lesion candidate L that the user gets stressed.

When the size of the lesion candidate L is less than the size threshold value, the mark distance determination portion P3b makes a determination to set the distance between the lesion candidate L and the mark to the second predetermined distance B2 so as to prevent the occurrence of a case where the mark is so far from the lesion candidate L that the mark is hardly recognized.

As shown in FIG. 7, when the size of the lesion candidate L is equal to or more than the size threshold value, the mark thickness determination portion P3c makes a determination to set the line of the mark to the first predetermined thickness C1 so as to prevent the occurrence of a case where the whole image becomes so complicated that the user gets stressed.

When the size of the lesion candidate L is less than the size threshold value, the mark thickness determination portion P3c makes a determination to set the line of the mark to the second predetermined thickness C2 such that the mark becomes apparent.

As shown in FIG. 8, when the size of the lesion candidate L is equal to or more than the size threshold value, the mark color determination portion P3d makes a determination to set the color of the mark to the first predetermined color D1 so as to prevent the occurrence of a case where the mark is so apparent that the user gets stressed. When the size of the lesion candidate L is less than the size threshold value, the mark color determination portion P3d makes a determination to set the color of the mark to the second predetermined color D2 such that the mark becomes apparent.

The mark color determination portion P3d determines the color of the mark by generating a predetermined operation based on the color of mucous membrane of the predetermined peripheral region of the lesion candidate L such that the mark becomes apparent.

When the color of the bubbles or the residue is detected, the mark color determination portion P3d determines color of the mark by performing a predetermined operation based on the color of the bubbles or the residue such that the mark becomes apparent.

As shown in FIG. 9, when the swelling direction of the lesion candidate L is detected and the kind of the mark is determined to the region mark A1 in the mark kind determination portion P3a, the mark position determination portion P3e makes a determination to set the display position to the position at which the second center point E2 is indicated from the outside of the swelling side of the lesion candidate L such that the position mark A1 can indicate the lesion candidate L.

When the swelling direction of the lesion candidate L is detected and the kind of the mark is determined to the region mark A2 in the mark kind determination portion P3a, the mark position determination portion P3e determines the display position at the position where the mark A2 surrounds the lesion candidate L and the predetermined region E3 on the outside of the base portion side of the lesion candidate L such that the mark is not arranged on a boundary between a normal mucous membrane and the lesion candidate L.

When the brightness of the predetermined peripheral region of the lesion candidate L is equal to or more than the brightness threshold value, the mark brightness determination portion P3f makes a determination to set the brightness of the mark to the first predetermined brightness such that the mark is easily observed by decreasing the brightness. When the brightness of the predetermined peripheral region of the lesion candidate L is less than a brightness threshold value, the mark brightness determination portion P3f makes a determination to set the brightness of the mark to the second predetermined brightness such that the mark is easily observed by increasing the brightness.

When the endoscope image X is inputted from the endoscope image generating unit 32 to the display image generating unit 35 and the mark display information Y is inputted from the display control unit 34 to the display image generating unit 35, the display image generating unit 35 generates the display image Z based on the endoscope image X and the mark display information Y. More specifically, the display image generating unit 35 arranges the mark on the endoscope image X according to the coordinate information of the lesion candidate L, the kind of the mark, the distance between the lesion candidate L and the mark, the thickness of the line of the mark, the color of the mark, the position of the mark, and the brightness of the mark included in the mark display information Y, generates the display image Z, and outputs the display image Z to the display unit 41. The display unit 41 displays the display image Z.

With such a configuration, the endoscope apparatus 1 can display the display image Z on the display unit 41 by adding the mark indicating the lesion candidate L to the endoscope image X according to the feature of the lesion candidate L in the endoscope image X such that the mark does not obstruct the observation of the lesion candidate L.

According to the embodiment, the image processing device 31 can add the mark indicating the lesion candidate L to the endoscope image X according to the feature of the lesion candidate L such that the lesion candidate L is more easily observed.

Note that, in this embodiment, the feature detection section P2 includes the kind detection portion P2a, the profile clearness detection portion P2b, the size detection portion P2c, the mucous membrane color detection portion P2d, the bubble and residue detection portion P2e, the swelling direction detection portion P2f, and the brightness detection portion P2g, and the mark determination section P3 includes the mark kind determination portion P3a, the mark distance determination portion P3b, the mark thickness determination portion P3c, the mark color determination portion P3d, the mark position determination portion P3e, and the mark brightness determination portion P3f. However, the image processing device 31 may be formed by using some of these portions. For example, the image processing device 31 may be configured such that the feature detection section P2 includes the size detection portion P2c, and the mark determination section P3 includes at least one of the mark distance determination portion P3b which determines the distance between the lesion candidate L and the mark, the mark thickness determination portion P3c which determines the thickness of the line of the mark, and the mark color determination portion P3d which determines the color of the mark; the size detection portion P2c detects whether the size of the lesion candidate L is equal to or more than the size threshold value or less than the size threshold value; and the mark determination section P3 determines the display state of the mark based on the detection result of the size detection portion P2c.

Note that, in this embodiment, the display control unit 34 performs the detection of the lesion candidate L and the detection of the feature of the lesion candidate L by executing the program of the lesion detection section P1 and the program of the feature detection section P2. However, the detection of the lesion candidate L and the detection of the feature of the lesion candidate L may be performed by an arithmetic operation using the artificial intelligence technology such as machine learning. Further, the lesion detection section P1, the feature detection section P2, the mark determination section P3, the display control unit 34, and the display image generating unit 35 may be arranged at a plurality of casings in a divided manner, or these sections and units may not be always integrally formed with the image processing device 31.

In this specification, each “unit”, each “section”, and each “portion” are conceptual components corresponding to respective functions of the embodiment, and do not always correspond to specific hardware or software routine on a one-to-one basis. Accordingly, in this specification, the embodiment has been described by estimating imaginary blocks (units, sections, portions) having the respective functions of the embodiment. Further, the respective steps in each process of this embodiment may be performed in such a manner that the order of performing the steps is changed, a plurality of steps are performed simultaneously, or the order of steps is changed each time so long as such modifications conforms with the characteristic features of the embodiment. Further, all or some of the respective steps in the respective processes in this embodiment may be realized by a hardware.

The present invention is not limited to the above-mentioned embodiment, and various change, modifications and the like are conceivable without departing from the gist of the present invention.

What is claimed is:

1. An image processing device comprising a processor, wherein the processor is configured to:
detect a lesion candidate based on a medical image obtained by picking up an image of a subject;
detect a feature including a swelling direction of the lesion candidate;
determine a display state of a mark displayed according to the feature of the lesion candidate, and generate mark display information including information on the display state; and
determine a position of the mark in a predetermined peripheral region of the lesion candidate according to the detected swelling direction, and
the image processing device is configured to generate a display image in which the mark is added at the position of the mark of the medical image based on the mark display information.

2. The image processing device according to claim 1, wherein the processor is configured to:
detect whether a kind of the lesion candidate is a raised lesion or a flat lesion; and
determine a kind of the mark according to the kind of the lesion candidate among plural kinds of the mark.

3. The image processing device according to claim 2, wherein the processor is configured to make a determination to set the kind of the mark to a position mark indicating a position of the lesion candidate when the kind of the lesion candidate is the raised lesion, and is configured to make a determination to set the kind of the mark to a region mark indicating a region of the lesion candidate when the kind of the lesion candidate is the flat lesion.

4. The image processing device according to claim 1, wherein the processor is configured to detect whether a clearness of a profile of the lesion candidate is equal to or more than a clearness threshold value or less than the clearness threshold value.

5. The image processing device according to claim 4, wherein the processor is configured to make a determination to set a distance between the lesion candidate and the mark to a first predetermined distance when the clearness of the profile of the lesion candidate is equal to or more than the clearness threshold value, and is configured to make a determination to set the distance between the lesion candidate and the mark to a second predetermined distance shorter than the first predetermined distance when the clearness of the profile of the lesion candidate is less than the clearness threshold value.

6. The image processing device according to claim 1, wherein the processor is configured to:
determine at least one of a distance between the lesion candidate and the mark, a thickness of a line of the mark, and a color of the mark;
detect whether a size of the lesion candidate is equal to or more than a size threshold value or less than the size threshold value; and
determine a display state of the mark based on a detection result.

7. The image processing device according to claim 6, wherein the processor is configured to make a determination to set the distance between the lesion candidate and the mark to a first predetermined distance when the size of the lesion candidate is equal to or more than the size threshold value, and is configured to make a determination to set the distance between the lesion candidate and the mark to a second predetermined distance shorter than the first predetermined distance when the size of the lesion candidate is less than the size threshold value.

8. The image processing device according to claim 6, wherein the processor is configured to make a determination to set the thickness of the line of the mark to a first predetermined thickness when the size of the lesion candidate is equal to or more than the size threshold value, and is configured to make a determination to set the thickness of the line of the mark to a second predetermined thickness which is larger than the first predetermined thickness when the size of the lesion candidate is less than the size threshold value.

9. The image processing device according to claim 6, wherein the processor is configured to make a determination to set the color of the mark to a first predetermined color when the size of the lesion candidate is equal to or more than the size threshold value, and is configured to make a determination to set the color of the mark to a second predetermined color when the size of the lesion candidate is less than the size threshold value.

10. The image processing device according to claim 1, wherein the processor is configured to determine a display position of the mark such that the mark is not arranged in a predetermined region on an outside of a base portion of the lesion candidate.

11. The image processing device according to claim 1, wherein the processor is configured to:
detect whether a brightness of a predetermined peripheral region of the lesion candidate is equal to or more than a brightness threshold value or less than the brightness threshold value; and
determine brightness of the mark according to the brightness of the predetermined peripheral region of the lesion candidate.

12. The image processing device according to claim 11, wherein the processor is configured to make a determination to set the brightness of the mark to a first predetermined brightness lower than the brightness threshold value when the brightness of the predetermined peripheral region of the lesion candidate is higher than the brightness threshold value, and is configured to make a determination to set the brightness of the mark to a second predetermined brightness higher than the brightness threshold value when the brightness of the predetermined peripheral region of the lesion candidate is lower than the brightness threshold value.

13. The image processing device according to claim 1, wherein the processor is configured to:
detect a color of a mucous membrane in the predetermined peripheral region of the lesion candidate; and
determine a color of the mark by performing a predetermined color arithmetic operation based on the color of the mucous membrane.

14. The image processing device according to claim 13, wherein a color farthest in distance in a predetermined color space is calculated in the predetermined color arithmetic operation.

15. The image processing device according to claim 1, wherein the processor is configured to:
detect bubbles or a residue in the predetermined peripheral region of the lesion candidate; and
determine a color of the mark by performing a predetermined color arithmetic operation based on the color of the bubbles or the residue.

16. The image processing device according to claim 15, wherein a color farthest in distance in a predetermined color space is calculated in the predetermined color arithmetic operation.

17. A computer readable non-transitory recording medium in which an image processing program is recorded, the recording medium comprising:
a code in accordance with which a lesion candidate is detected based on a medical image obtained by picking up an image of a subject;
a code in accordance with which a feature including a swelling direction of the lesion candidate is detected;
a code in accordance with which a display state of a mark which is displayed is determined according to the feature of the lesion candidate, and mark display information including the information on the display state is generated;
a code in accordance with which a position of the mark in a predetermined peripheral region of the lesion candidate is determined according to the detected swelling direction; and
a code in accordance with which a display image is generated by adding the mark to a position of the mark of the medical image based on the mark display information.

18. An image processing method comprising:
detecting a lesion candidate based on a medical image obtained by picking up an image of a subject;
detecting a feature including a swelling direction of the lesion candidate;
determining a display state of a mark which is displayed according to a feature of the lesion candidate, and generating mark display information including information on the display state;
determining a position of the mark in a predetermined peripheral region of the lesion candidate according to the detected swelling direction; and
generating a display image by adding the mark to a position of the mark of the medical image based on the mark display information.
